(19) United States
(12) Patent Application Publication
(10) Pub. No.: US 2017/0219233 A1
(43) Pub. Date: Aug. 3, 2017

(54) MULTI-LAYER OPTIMAL CHILLER OPERATION MANAGEMENT FRAMEWORK

(71) Applicant: NEC Laboratories America, Inc., Princeton, NJ (US)

(72) Inventors: Yanzhu YE, SAN JOSE, CA (US); Ratnesh SHARMA, FREMONT, CA (US); Feng GUO, SUNNYVALE, CA (US)

(21) Appl. No.: 15/417,233

(22) Filed: Jan. 27, 2017

Related U.S. Application Data
(60) Provisional application No. 62/288,508, filed on Jan. 29, 2016.

(51) Int. Cl. F24F 11/00; G05B 19/048; G05B 19/042; F24F 5/00

(52) U.S. Cl. CPC F24F 11/006; F24F 5/0003; G05B 19/048; G05B 19/0426; F24F 2011/0067; F24F 2011/0075; F24F 2011/0061; G05B 2219/2614

(57) ABSTRACT

Aspects of the present disclosure describe a multi-layer chiller operation management framework and associated methods for managing heating, ventilation, and air conditioning (HVAC) multi-chiller unit operation in real time serving varying system loads. According to the present disclosure, the framework includes two layers—a first layer providing 24-hour chiller operation planning thereby optimizing chiller operation using forecasted load profiles to minimize energy consumption. To this is applied a mixed-integer linear programming (MILP) based optimization. A second layer adjusts chiller operation status in real-time based on actual system load demand. Load forecasting uncertainty is cured in a hierarchical manner based on the level of load uncertainty. Two approaches are employed namely rule-based load sharing adjustment and MILP-based rolling optimization.

### CROSS REFERENCE TO RELATED APPLICATIONS

This application claims the benefit of U.S. Provisional Patent Application Ser. No. 62/288,508 filed Jan. 29, 2016 which is incorporated by reference as if set forth at length herein.

### TECHNICAL FIELD

This disclosure relates generally to energy management systems and methods. More particularly it pertains to frameworks, methods and systems for optimal chiller operation.

### BACKGROUND

As is known, building operations are a significant consumer of energy in the United States. Among all the energy consumed by such building operation—heating, ventilation and air conditioning (HVAC) systems and operations account for a large portion of that consumption. As is known, one particular system—the chiller plant—is widely used for HVAC systems and particularly for systems that are part of a campus environment. The chiller plant oftentimes includes multiple chiller units wherein individual units operate under different on/off schedules, different operational limits and exhibit different performance characteristics.

Given this importance, systems and methods that optimize or otherwise reduce the energy consumption and/or cost of operating such chiller systems would be a welcome addition to the art.

### SUMMARY

An advance in the art is made according to aspects of the present disclosure directed to frameworks, methods and systems for operation management of multi-layer chiller operation. According to an aspect of the present disclosure, a framework according to the present disclosure may be advantageously applied to managing multi-chiller operation in real-time to serve varying system loads.

Operationally, a framework according to the present disclosure includes two layers. The first of the layers manages day-ahead, 24-hour chiller operation planning and optimizes chiller operation using forecasted load profiles to minimize energy consumption. Advantageously, this first layer is a flexible and accurate modeling framework and employs MILP-based optimization.

The second layer adjusts chiller operation in real-time based on actual system load and/or demand. This layer addresses load uncertainty during real-time system operation and maintains optimal chiller operation. Load forecasting uncertainty is solved in a hierarchal way, based on the level of load uncertainty.

According to the present disclosure and in sharp contrast to the prior art—when the amount of uncertainty—the difference between forecasted load and real-time demand—is low a rule based chiller load sharing adjustment is made. When the amount of uncertainty is higher—and one or more chillers need to be started or stopped—a MILP-based rolling optimization is performed.

Advantageously, the framework according to the present disclosure not only provides optimal day-ahead chiller scheduling—but provides continuous real-time dispatching optimization as well.

### BRIEF DESCRIPTION OF THE DRAWING

A more complete understanding of the present disclosure may be realized by reference to the accompanying drawing in which:

FIG. 1 is a schematic diagram illustrating a prior art campus chiller plant;

FIG. 2 is a diagram illustrating a multi-layer chiller operation management framework according to an aspect of the present disclosure;

FIG. 3 is a flow diagram illustrating day-ahead mixed-integer linear programming (MILP) based optimization according to an aspect of the present disclosure;

FIG. 4 is a plot showing piecewise linearization of chiller efficiency curve according to an aspect the present disclosure;

FIG. 5 is a flow diagram illustrating real-time unit dispatch according to an aspect of the present disclosure;

FIGS. 6(A)-6(D) illustrate a flow diagram illustrating rule-based chiller load sharing adjustment according to an aspect of the present disclosure;

FIG. 7 is a flow diagram illustrating MILP-based rolling optimization according to aspects of the present disclosure;

FIG. 8 is a schematic block diagram illustrating a computer system on which methods according to the present disclosure may operate;

FIG. 9 is a graph illustrating chiller efficiency curves as applied to experimental operation and evaluation according to aspects of the present disclosure;

FIG. 10 is a graph illustrating system cooling load profiles under different uncertainty levels as applied to experimental operation and evaluation according to aspects of the present disclosure;

FIG. 11 is a graph illustrating day-ahead MILP-based chiller unit scheduling during experimental operation and evaluation according to aspects of the present disclosure;

FIG. 12 is a graph illustrating chiller unit operation results with multi-layer management framework during experimental operation and evaluation according to aspects of the present disclosure; and

FIG. 13 is a graph illustrating chiller operation energy cost under different uncertainty level during experimental operation and evaluation according to aspects of the present disclosure.

The illustrative embodiments are described more fully by the Figures and detailed description. Embodiments according to this disclosure may, however, be embodied in various forms and are not limited to specific or illustrative embodiments described in the drawing and detailed description.

### DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

The functions of the various elements shown in the Drawing, including any functional blocks labeled as “processors”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

Unless otherwise explicitly specified herein, the FIGs comprising the drawing are not drawn to scale.

Nomenclature Used in this Specification

The following nomenclature and their definition(s) as used in this Specification are shown in the following table.

| | |
|---|---|
| Cⱼ^{e}(t) | Energy cost at time period t of chiller unit j |
| Cⱼ^{s}(t) | Unit starting cost at time period t of chiller unit j |
| Qⱼ(t) | Load of chiller unit j at time t |
| Pⱼ(t) | Power output of chiller unit j at time t |
| N | Number of chiller units |
| T | Number of periods in the time span |
| U_{c,j} | Start-up cost of chiller unit j |
| Q_{min,j} | Minimum operation load of chiller unit j |
| Q_{max,j} | Maximum operation load of chiller unit j |
| D(t) | System load demand at time period t |
| aⱼ,bⱼ,cⱼ | Coefficients of the quadratic production cost function of chiller unit j |
| mUTⱼ | Minimum up time constraint of chiller unit j |
| mDTⱼ | Minimum down time constraint of chiller unit j |
| UT_{total,j} | Maximum daily total ontime for chiller unit j |
| UTⱼ | Maximum continuous ontime for chiller unit j |
| υⱼ(k) | Binary variables, 1 when unit j is online at time period k, otherwise 0 |
| υⱼ(0) | Binary variables, the initial status of chiller unit j before optimization |
| | time frame |
| Gⱼ | The length of the time span the unit j has been on the initial status |
| | υⱼ(0) |

By way of some additional background, we again note that building and building operations are one of the primary energy “consumers” in the United States and elsewhere. Among all energy consumed by such building operations, heating ventilation and air conditioning (HVAC) accounts for a large portion. One element of such HVAC systems—a chiller plant—is a primary component of these HVAC systems and is oftentimes found in campus environments where a common set of facilities serve a number of individual buildings. As is known, chiller plants oftentimes include multiple individual chiller units wherein each individual unit operates under different on/off periods, different operation limits and exhibits different performance characteristics. Accordingly, energy management systems and methods for multi-chiller unit operation is a critical component of efficient and economical HVAC operation.

Importantly, such energy management system(s) present challenging optimization problems. In particular, optimization complexity with respect to the high-dimensionality and non-linear system models employed and system load uncertainty during real-time operation—all the while maintaining system limits and operation optimization.

As may now be appreciated by those skilled in the art, such energy management systems exhibit challenging optimization problems which involve large-scale, non-linear, mixed-integer programming. Meanwhile, system cooling loads for multi-chiller units usually are very large and vary over a broad range greatly depending on weather and building conditions. As a result, in order to derive accurate system load profiles for optimal chiller unit scheduling, accurate load forecasting approaches are required. Unfortunately, such forecasting is not completely accurate and discrepancies may produce multiple chiller units to shut-down or start-up—which will greatly disturb an optimal unit scheduling sequence.

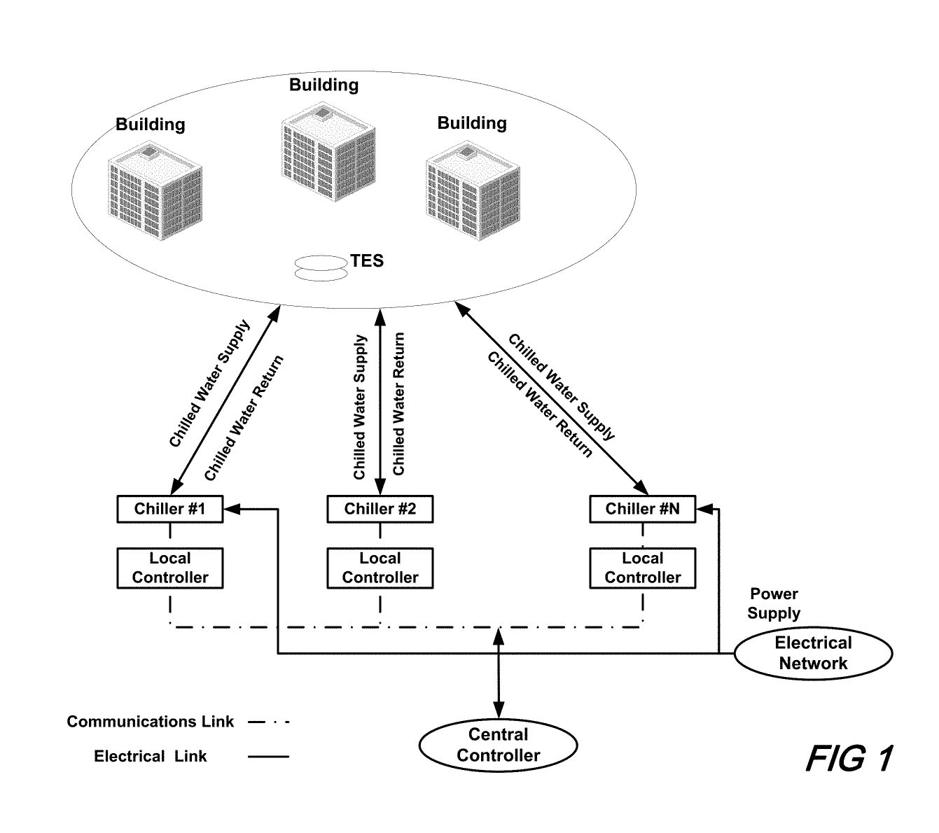

With this more complete background in place, we turn to FIG. 1 which illustrates in schematic form a typical campus chiller plant as is known in the art. As depicted in that FIG. 1, the campus may include a number of buildings which are supported by an event Thermal Energy Storage (TES) load and by a common HVAC system including a number of individual chillers as part of a multi-chiller system. As shown, each of the individual chillers may include a local controller which in turn is in communication with a central controller that controls the multi-chiller operation.

As may be readily appreciated by those skilled in the art, each individual chiller system in the overall campus system may include a local controller which controls flow rate, temperature settings, etc., for that individual chiller. Additionally, each individual chiller unit will likely have different energy requirements that are related to cooling load imposed on the unit(s). The central controller and management system, makes overall system control and management decisions based on current system loading, demand, operation status and performance. As we shall show, the inventive framework and associated methods according to the present disclosure may advantageously operate in the central controller which may include one or more digital computers as we shall describe herein.

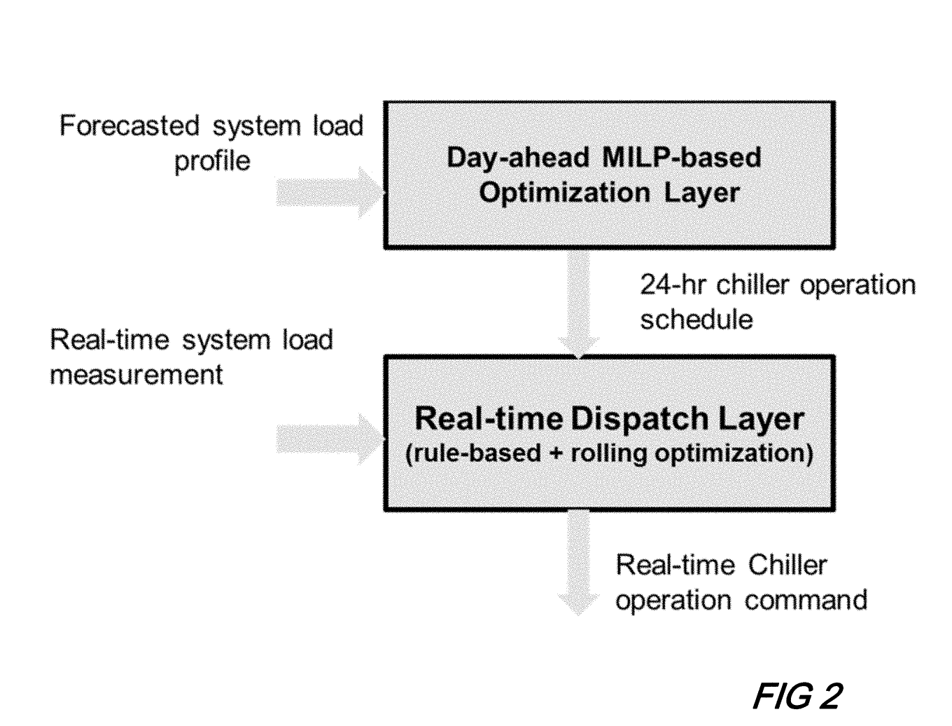

Turning now to FIG. 2 there is shown a block diagram illustrating a multi-layer chiller operation management framework according to an aspect of the present disclosure. As may be observed from that FIG. 2, two layers are shown namely, a day-ahead MILP-based Optimization layer 101 and a real-time dispatch layer 102.

Operationally, the day-ahead MILP-based optimization layer (Block 101) receives as input a forecasted system load profile and produces as output a 24-hr chiller operation schedule. Similarly, the real-time dispatch layer (Block 102) receives as input real-time system load measurement(s) and the 24-hr chiller operation schedule and produces as output real-time chiller operation commands that are subsequently provided to individual chillers to effect their operation as appropriate.

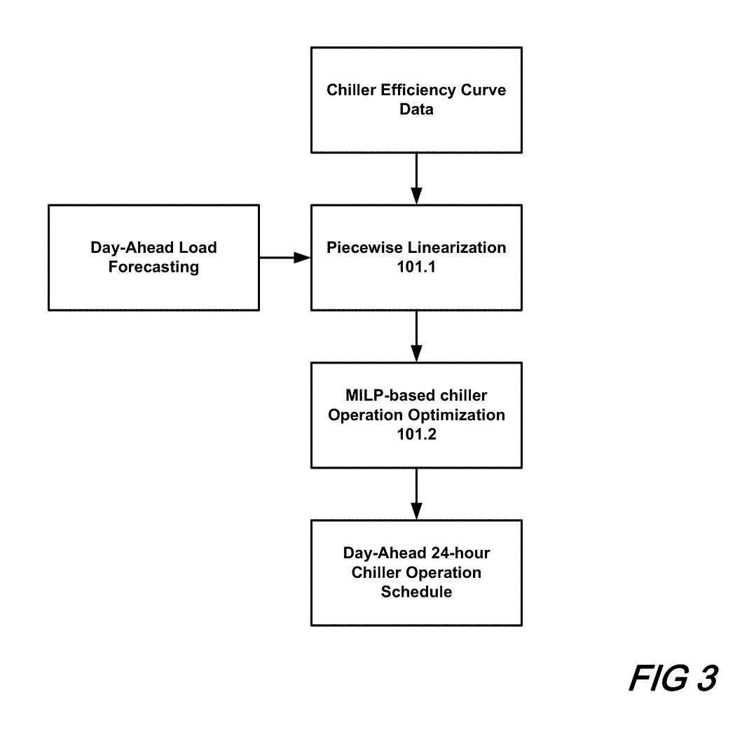

FIG. 3 is a flow diagram showing the steps associated with the day-ahead MILP-based optimization layer operation (Block 101). As shown, a piecewise linearization is applied to a chiller efficiency curve (P-Q curve) to formulate the optimization problem with mixed-integer linear expressions (Block 101.1). Meanwhile, the next-24 hour system load profile is forecasted and is used as input to a MILP-based chiller operation optimization (Block 101.2). Output from this process is a 24-hour multi-chiller operation schedule—including unit on/off sequences.

### Block 101.1

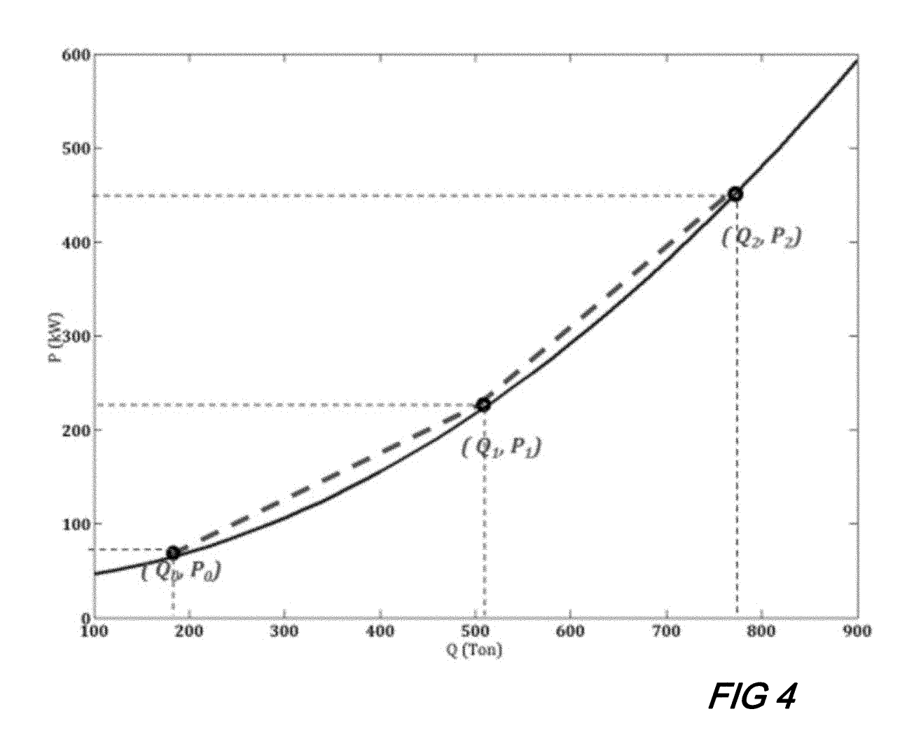

Continuing with our discussion of FIG. 3, and in particular with respect to Block 101.1 in which the piecewise linearization is applied, we may understand this operation with simultaneous reference to FIG. 4. which graphically shows a piecewise linearization of chiller efficiency curve (P/Q curve). If we use such P/Q curve as an example, the P/Q quadratic function can be approximated by piecewise blocks. If we assume there are M piecewise blocks, the value for M+1 breaking points are defined as (Qᵢ, P), i=0, 1 . . . M

The incremental method is applied to model the piecewise linear function. The P, Q value may be presented as:

Q=Q₀+Σⱼ₌₁^{M}δⱼ(Qⱼ−Qⱼ₋₁) (1)

P=P₀+Σⱼ₌₁^{M}δⱼ(Pⱼ−Pⱼ₋₁) (2)

δⱼ₊₁≦δⱼ;δ₁≦1;δ_{M}≧0

γᵢε{0,1}∀jε{1,2, . . . M−1}

### Block 101.2

The chiller optimization objective function and system operation constraints are formulated using mixed-integer linear expressions. Accordingly, the chiller operation optimization objective may be formulated as:

$${\sum }_{t = 1}^{T} {\sum }_{j = 1}^{N} {C}_{j}^{e} ( t ) + {C}_{j}^{s} ( t ) \qquad ( 3 )$$

subject to:

Demand and load balance at time t represented by:

$${\sum }_{j = 1}^{N} {Q}_{j} ( t ) = D ( t ) ; t = 1 , 2 , … T \qquad ( 4 )$$

Generation constraint for each chiller unit represented by:

Q_{min,j}≦Qⱼ(t)≦Q_{max,j};t−1,2, . . . T;j=1,2, . . . N (5)

Minimum uptime/downtime constraints; and

Maximum total operation time constraints.

### Objective Function Formulation

As may be observed, there are two components employed in the objective function of Eq. (3). They may be described as follows:

1. Energy Cost Cⱼ^{e}(k)

Considering the time of use rate at time k, TOU(k), the energy cost Cⱼ^{e}(k) may be formulated as:

Cⱼ^{e}(k)=Eⱼ^{e}(k)TOU(k)=Pⱼ(k)ΔTTOU(k) (6)

The chiller power consumption Pⱼ(k), at time period k is described as quadratic function of cooling load as in Eq. (7):

Pⱼ(k)=aⱼ+bⱼQⱼ(k)+cⱼQⱼ²(k) (7)

Considering the piecewise linearization of the P-Q quadratic function described in Block 101.1, the piecewise linear functions in Eq. (1) and Eq. (2) applies to each chiller unit at each time period k, the P, Q value may be rewritten as:

Pⱼ(k)=P_{j,0}+Σₙ₌₁^{M}δ_{j,n}(k)(P_{j,n}−P_{j,n-1})∀k=1,2, . . . T;j=1,2 . . . N (8)

Qⱼ(k)=Q_{j,0}+Σₙ₌₁^{M}δ_{j,n}(k)(Q_{j,n}−Q_{j,n-1})∀k=1,2, . . . T;j=1,2 . . . N (9)

Where Q_{j,n}, P_{j,n} (n=0, 1, . . . , M) is breaking point value of piecewise linearization of Q-P quadratic function of chiller unit j, and Q_{j,n}, P_{j,n} can be predetermined and calculated as a constant value.

### Constraints Formulation

We note the following additional definitions:
Demand and load balance at time t may be defined by:

$${\sum }_{j = 1}^{N} {Q}_{j} ( k ) = D ( k ) ; k = 1 , 2 , … T \qquad ( 10 )$$

Chiller cooling load limit, namely the output load of each chiller unit is limited as follows:

vⱼ(k)Q_{j,min}≦Q_{j,n}(k)≦vⱼ(k)Q_{j,max}∀k=1,2, . . . T;j=1,2 . . . N (11)

The vⱼ(k) is the on/off status of chiller unit j at time period k, if vⱼ(k) equals zero, which means the chiller unit is turned off, the output load will be zero, otherwise the output load could be any value between minimum and maximum limits
Minimum up/downtime limit
   The minimum up/downtime constraints are formulated as mixed-integer linear expression based on binary on/off status variables vⱼ(k). Meanwhile considering the initial operation status of each chiller unit, the operation constraints for each unit are formulated dynamically. Notably, there are two parameter sets defined to present the initial chiller operation status (vⱼ(0), Gⱼ), where vⱼ(0) is the initial on/off status for chiller unit j before the optimization time span, Gⱼ is the length of time span the unit j has been on the initial status.

### Minimum Uptime Constraints:

For a first operation time period, t=1, the constraints are formulated dynamically as follows:
When the chiller unit remains “off” (shutdown) initially (vⱼ(0)=0):

Σₖ₌₁^{mUT}vⱼ(k)≧mUTⱼvⱼ(1)jε(1,2 . . . N) (12)
When the chiller unit remains “on” initially (vⱼ(0)=1) for Gⱼ time span: if Gⱼ<mUTⱼ then:

Σₖ₌₁^{mUT}^{ⱼ}^{-G}(1−vⱼ(k)≦0jε(1,2 . . . N) (13)
if Gⱼ>mUTⱼ then:

vⱼ(1)≧0
For the following operation time spans, e.g., t=2, 3, . . . T, the constraints are formulated as:

$$\begin{matrix}{\sum }_{k = t}^{t + {mUT}_{j} - 1} ( {v}_{j} ( k ) \geq {mUT}_{j} [ {v}_{j} ( t ) - {v}_{j} ( t - 1 ) ] ∀ t = 2 , … t - {mUT}_{j} + 1 ; j ∈ ( 1 , 2 … N ) & ( 14 ) \\ {\sum }_{k = t}^{T} ( {v}_{j} ( k ) ] \geq ( T - t + 1 ) [ {v}_{j} ( t ) - {v}_{j} ( t - 1 ) ] ∀ t = T - {mUT}_{j} + 2 , … T ; j ∈ ( 1 , 2 … N ) & ( 15 )\end{matrix}$$

We note that Eq. (14) defines the constraints for the subsequent time period in which once one chiller unit is started up it should be on at least mUTⱼ time periods. Eq. (15) models the final mUTⱼ−1 time period, during which if chiller unit j had just started up, it should remain on until the end of the time span.

### Minimum Downtime Constraints:

Similar to the minimum uptime constraints formulated in Eq. (12)˜Eq. (15), the minimum downtime constraints are formulated dynamically. For the first operation time period t=1, the constraints are formulated dynamically as follows:
When the chiller unit stays on initially (vⱼ(0)=1), or the unit has been started up before the optimization Time frame:

Σₖ₌₁^{mUT}^{ⱼ}(1−vⱼ(k)≧mDTⱼ[1−vⱼ(1)]jε(1,2 . . . N) (16)
When the chiller unit stays off initially (vⱼ(0)=0) for Gⱼ time span if Gⱼ<mDTⱼ then

Σₖ₌₁^{mUT}^{ⱼ}^{-G}^{ⱼ}vⱼ(k)≦0jε(1,2 . . . N) (17)
if Gⱼ>mDTⱼ then

vⱼ(1)≧0
For the following operation time spans, e.g., t=2, 3, . . . T, the constraints are formulated as:

$$\begin{matrix}{\sum }_{k = t}^{t + {mDT}_{j} - 1} [ 1 - {v}_{j} ( k ) ] \geq {mDT}_{j} [ {v}_{j} ( t - 1 ) - {v}_{j} ( t ) ] ∀ t = 2 , … t - {mUT}_{j} + 1 ; j ∈ ( 1 , 2 … N ) \\ & ( 18 ) \\ {\sum }_{k = t}^{t} [ 1 - {v}_{j} ( k ) ] \geq ( T - t + 1 ) [ {v}_{j} ( t - 1 ) - {v}_{j} ( t ) ] ∀ t = T - {mDT}_{j} + 2 , … T ; j ∈ ( 1 , 2 … N ) & ( 19 )\end{matrix}$$

Eq. (18) defines the constraints for the time period in which when one chiller unit is just shut down it should be kept off at least mDTⱼ consecutive time periods. Eq. (19) models the final mDTⱼ−1 time period, during which if chiller unit j is just shut down, it should remain off until the end of the time span.

Σₖ₌₁^{1+UT}^{ⱼ}^{-G}^{ⱼ}vⱼ(k)≦UTⱼ;jε1,2 . . . N (20)

Σₖ₌ₜ^{t+UT}^{ⱼ}vⱼ(k)≦UTⱼt=2,3, . . . T−UTⱼ;jε1,2 . . . N (21)
When the chiller unit stays off before optimization time span (vⱼ(0)=0) the constraints are formulated as:

Σₖ₌ₜ^{t+UT}^{ⱼ}vⱼ(k)≦UTⱼt=1,2, . . . T−UTⱼ;jε1,2 . . . N (22)
Maximum daily total uptime for each unit—the maximum daily total uptime for each chiller unit is also formulated as mixed-integer linear expression:

Σₖ₌₁^{T}vⱼ(k)≦UT_{total,j};∀jε1,2 . . . N (23)

In summary, the objective function and constraints are formulated in mixed-integer linear expressions. Assume the number of segment of piecewise linear chiller P-Q functions is 2, for each chiller unit j, the optimization variables are defined as:

[δ_{1,j}(k),ε_{2,j}(k),γ_{1,j}(k),vⱼ(k),Cⱼ^{s}(t)]∀kε1,2 . . . T;

and the total number of variables is 5×N×T. The number of binary inters is 2×N×T.

### Block 102

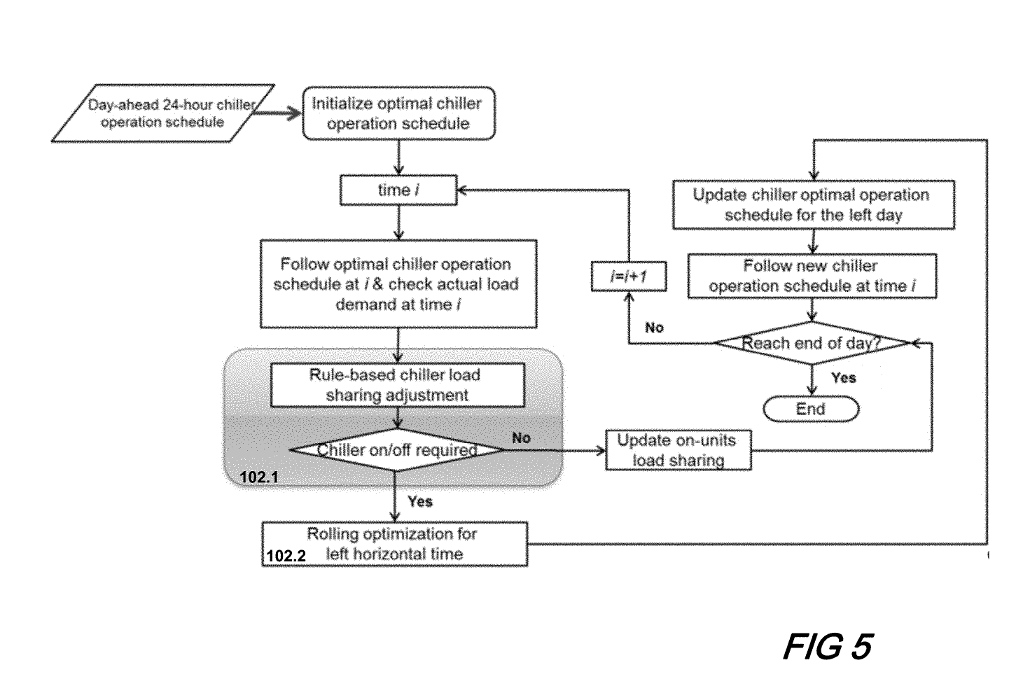

Turning now to FIG. 5, there is shown a flow diagram illustrating operation of the real-time dispatch layer (Block 102). The operation depicted may operate periodically, i.e., hourly or every 30 minutes—or any other period as necessary. Notably, there are different approaches are included in this real-time dispatch layer namely, chiller load sharing adjustment (Block 102.1) and MILP-based rolling optimization (Block 102.2).

As may be observed from FIG. 5, a day-ahead 24-hour chiller operation schedule is received and an optimized chiller operation schedule is initialized. At a given time i, the optimal chiller operation schedule is followed and actual load demand is evaluated (Block 102.3). Subsequently, Rule-based chiller load sharing adjustment(s) is/are made followed by a determination of whether or not it is necessary to turn on/off the chiller. If “Yes”, then rolling optimization for the day left is performed (Block 102.2) followed by updating chiller optimal operation for schedule for the day, and then following that new operation schedule and repeating the above operations until the end of the day. If, on the other hand, no chiller on/off is required, then all that is required is an updating on any unit load sharing and repeating the above operations.

### Block 102.1—Rule-Based Chiller Load Sharing Adjustment

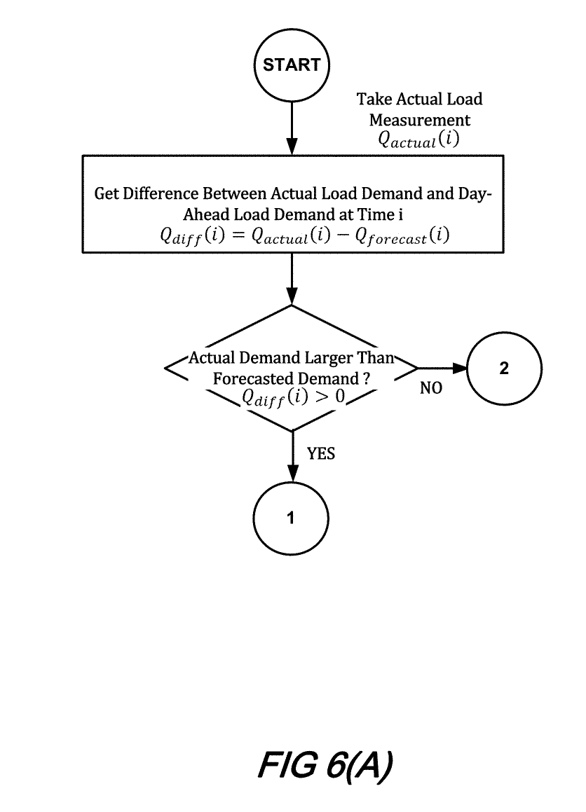

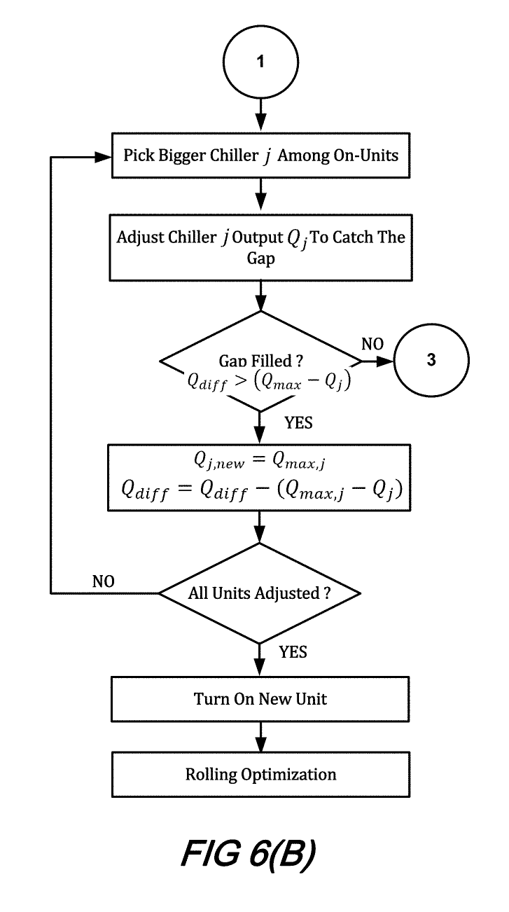

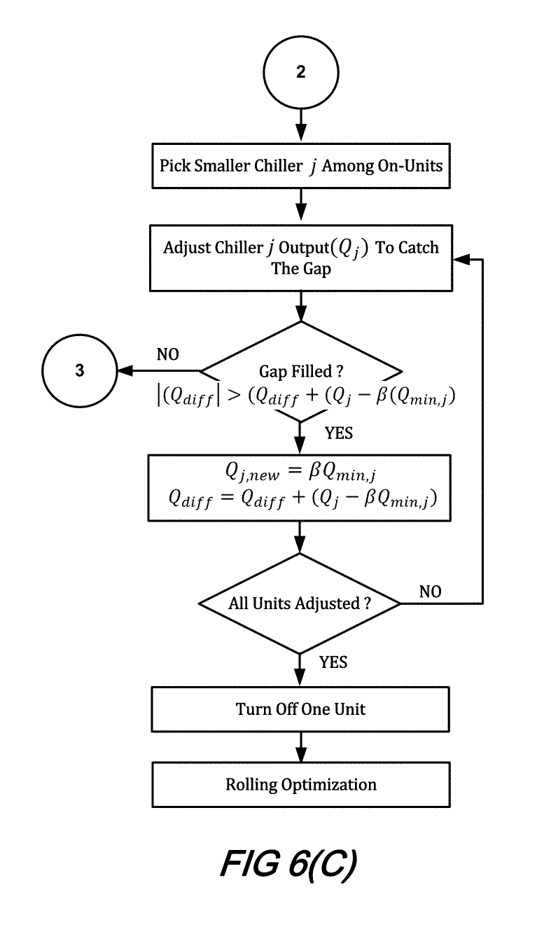

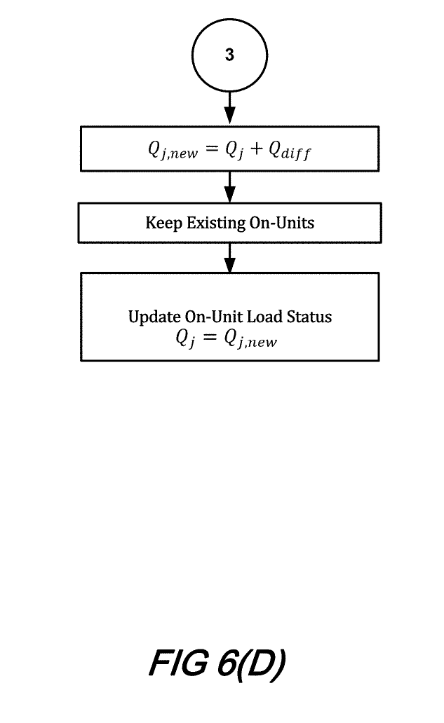

FIGS. 6(A)-6(D) shows a flow diagram showing the rule-based chiller load sharing adjustment employed in FIG. 5. Operationally, the multi-chiller operation according to the present disclosure will firstly follow the pre-planned chiller optimal operation schedule which advantageously minimizes system operation cost based on forecasted system load profile. However, since there are oftentimes discrepancies between actual system load and forecasting load, a rule-based load adjustment approach will firstly adjust the load sharing among those chillers that are already operating. However, if the discrepancies are too large, one or more additional chillers will need to be started or one or more existing operating chillers will need to be turned off, and the MILP-based rolling optimization (Block 102.2) will be triggered to update the chiller optimal operation schedule.

### Block 102.2—MILP-Based Rolling Optimization

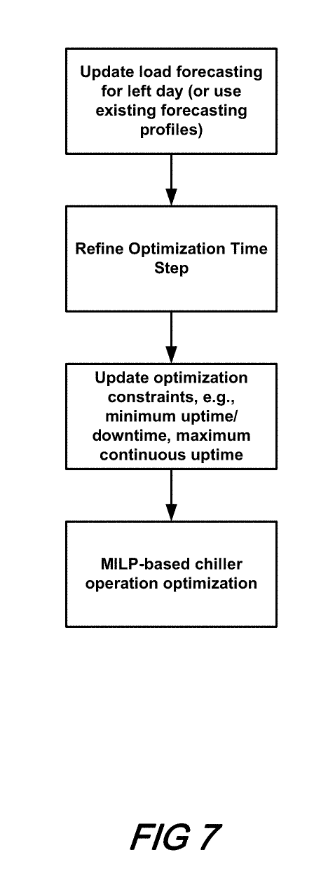

FIG. 7 is a flow diagram showing the rolling optimization. Notably, such rolling optimization is only activated when there are sufficiently large differences between the forecasting load and actual system load and therefore chiller on/off actions (one or more chillers must be turned on or off) need be taken.

The MILP-based rolling optimization (Block 102.2) invokes a procedure similar to that described with respect to Block 101.2. Notable differences between the two procedures include: First, the optimization time span is different, the rolling optimization only optimize the chiller operation for the remainder of the day; and it will not re-optimize the entire day every time. Second, the previous chiller operation history will be taken into account during rolling optimization, e.g., the optimization constraints needs be updated, and those constraint matrices will be dynamically generated. Third, the rolling optimization only optimize the chiller operation for the succeeding time period, when the system operates along the day, the optimization time step may be refined or reduced to have a more accurate and effective optimal chiller unit scheduling while still maintaining the computational complexity.

As shown in FIG. 7 MILP-based rolling optimization first updates load forecasting for the remainder of a day. It then refines optimization time step(s) and updates optimization constraints including constraints such as minimum uptime/downtime, maximum continuous uptime. Finally, MILP-based chiller operation optimization is performed.

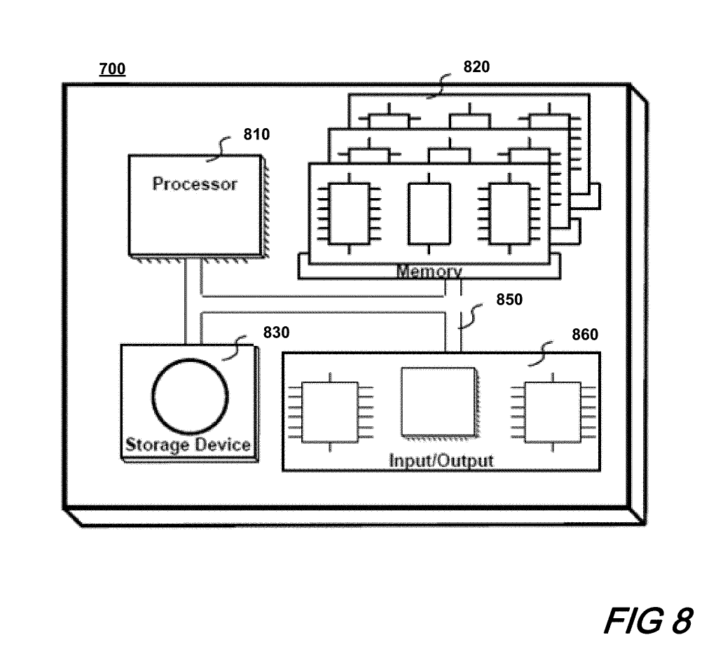

FIG. 8 shows an illustrative computer system 800 suitable for implementing the methods associated with our inventive framework according to an aspect of the present disclosure. As may be immediately appreciated, such a computer system may be integrated into another, larger networked system and may be implemented via discrete elements or one or more integrated components. The computer system may comprise, for example a computer running any of a number of operating systems. The above-described methods of the present disclosure may be implemented on the computer system 800 as stored program control instructions.

Computer system 800 includes processor 810, memory 820, storage device 830, and input/output structure 840. One or more input/output devices may include a display 845. One or more busses 850 typically interconnect the components, 810, 820, 830, and 840. Processor 810 may be a single or multi core. Additionally, the system may include accelerators etc. further comprising a system on a chip.

Processor 810 executes instructions in which embodiments of the present disclosure may comprise steps described in one or more of the Drawing figures. Such instructions may be stored in memory 820 or storage device 830. Data and/or information may be received and output using one or more input/output devices.

Memory 820 may store data and may be a computer-readable medium, such as volatile or non-volatile memory. Storage device 830 may provide storage for system 800 including for example, the previously described methods. In various aspects, storage device 830 may be a flash memory device, a disk drive, an optical disk device, or a tape device employing magnetic, optical, or other recording technologies.

Input/output structures 840 may provide input/output operations to one or more external control systems, that may be used to control and/or provide feedback to which computer system 800 is communicatively coupled. Input/output structures 840 may additionally provide any of a number of communications technologies in support of networking—both wired and/or wireless—and in certain instantiations may power the system as well. Input/output structures may also include any of a variety of known interface structures suitable for interconnecting additional capabilities such as Analog/Digital or Digital/Analog converters. Finally, note that these structures are presented as being illustrative and while shown as being discrete, they may be integrated into a single chip or other platform as design or application needs dictate.

### Experimental Case Studies

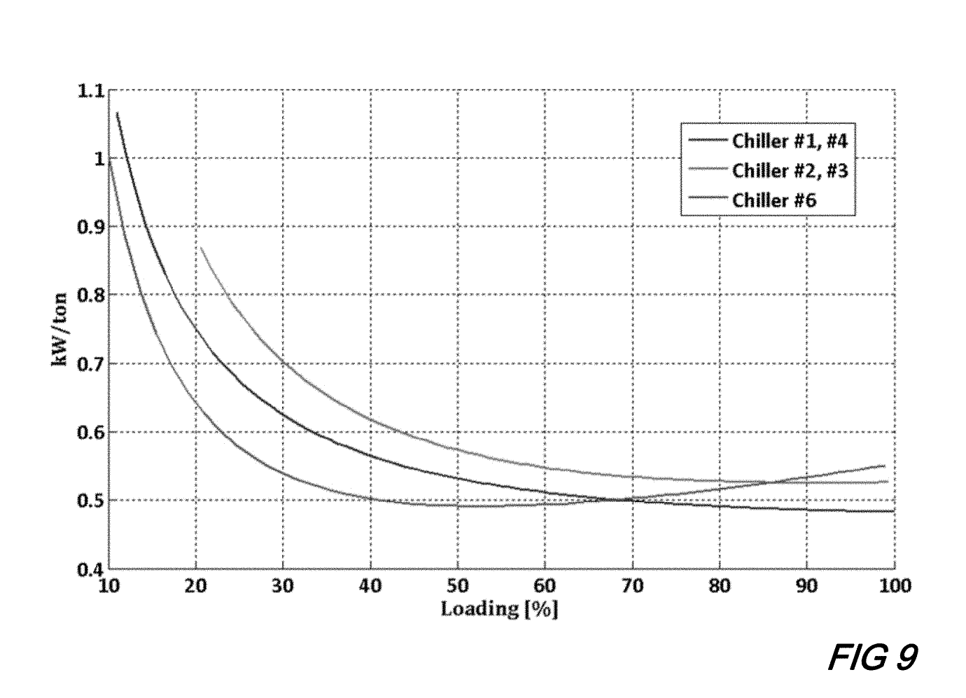

The multi-layer optimal chiller operation management framework is experimentally applied to a campus central chiller plant, where five chiller units are available for supplying chilled water to satisfy the campus cooling demand. The chiller efficiency curves are obtained from the chiller data sheet, as shown in FIG. 9. Only three types of chillers are available. The Q-P quadratic function are further derived from FIG. 9 and linearized through piecewise linear approximation with M=2. The simulation study is conducted using Matlab, with GLPK as the optimization solver. The optimization constraints are defined as: mUT=2, mDT=2, UT=20. The TOU rate are 0.2243 $/kWh for peak time from 7 AM to 11 PM, and 0.1421 $/kWh for non-peak time.

Since the load forecasting technique has been not covered in this paper, random error will be added on the actual loading profiles to approximate the forecasting error. The random error (Qₑᵣᵣₒᵣ) follows normal distribution. Various uncertainty levels with different variances σ² will be tested to verify the effectiveness of this management framework.

Q_{forecast}=Q_{actual}+Qₑᵣᵣₒᵣ

Qₑᵣᵣₒᵣ˜N(μ,σ²)

The operation cost is compared with the original campus chiller operation result in a university campus. The baseline operation case applies the heuristic rule-based chiller operation mechanism, which directly compares the building instantaneous cooling load with certain pre-defined threshold, then heuristically choose chillers to turn on or turn off.

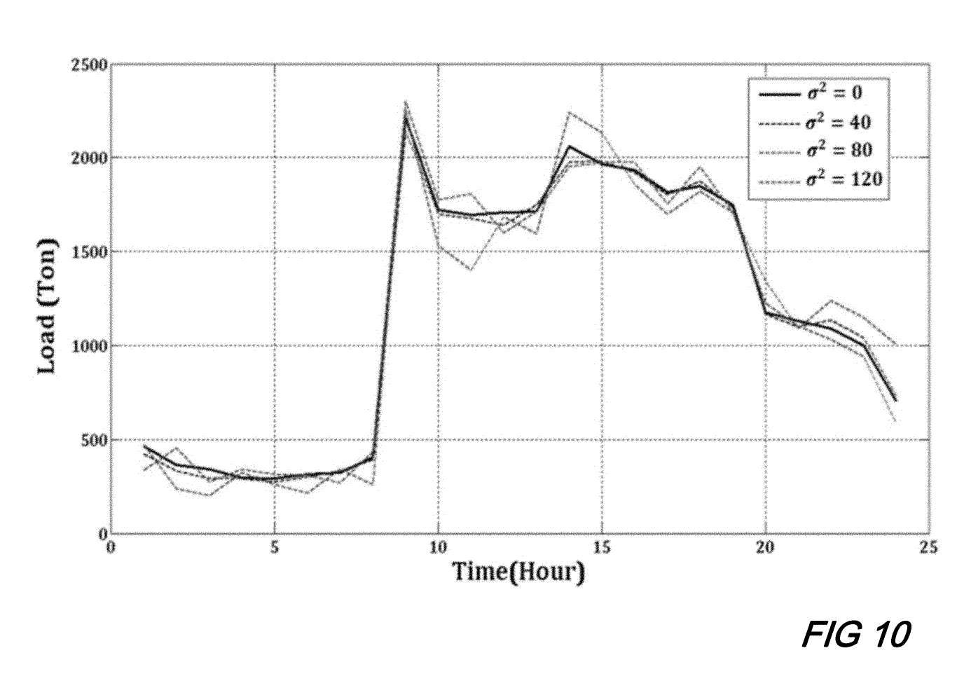

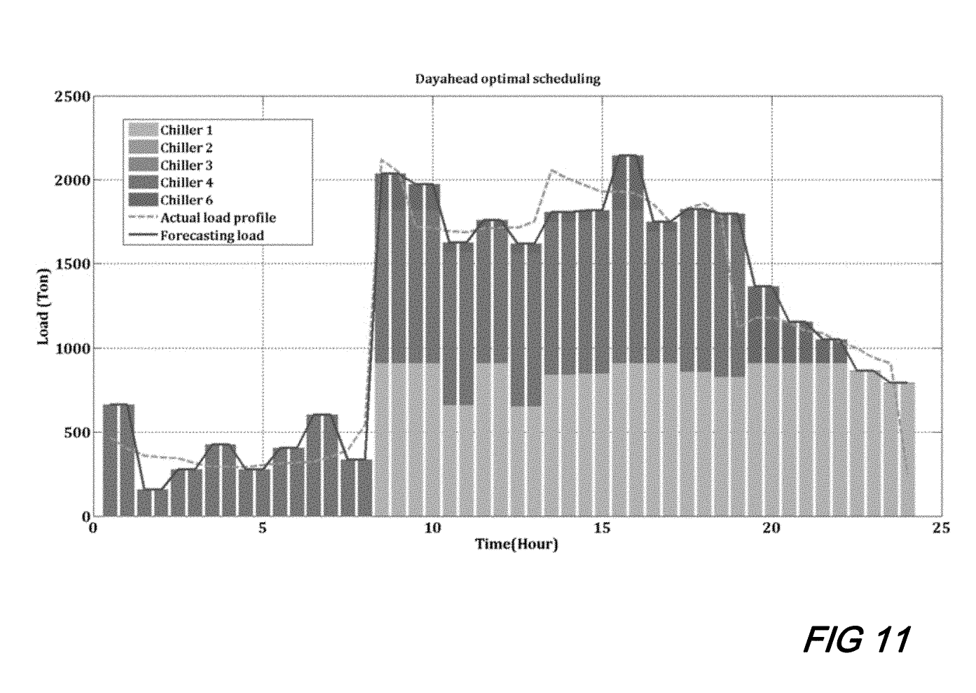

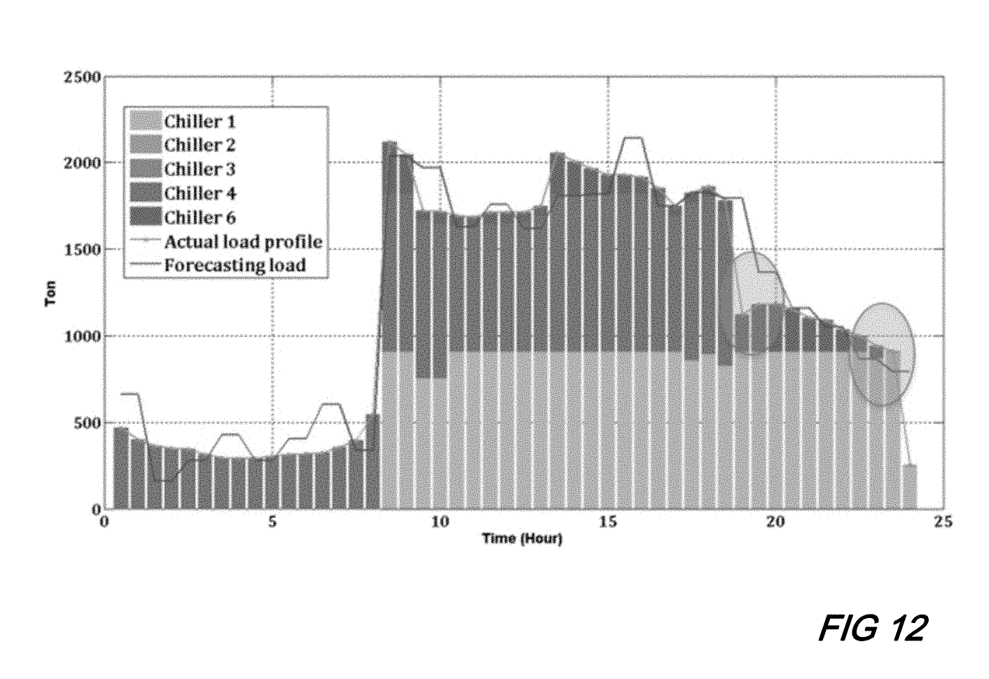

Take one-day actual campus building load as example. The forecasting error with different σ² is added as shown in Error! Reference source not found. The larger the variance σ², the higher the forecasting uncertainty. Take σ²=160 as example, the chiller unit scheduling results from the day-ahead MILP-based optimization layer are shown in FIG. 10. Based on the day-ahead operation scheduling, the real-time dispatching layer adjust the chiller operation status every 30 min to compensate the discrepancy between forecasting and actual system load. The final chiller unit commitment and load sharing is shown in FIG. 12. As noted in the blue circle in FIG. 11, the MILP-based rolling optimization is triggered when one new chiller needs to start up or one existing chiller needs to be shut down.

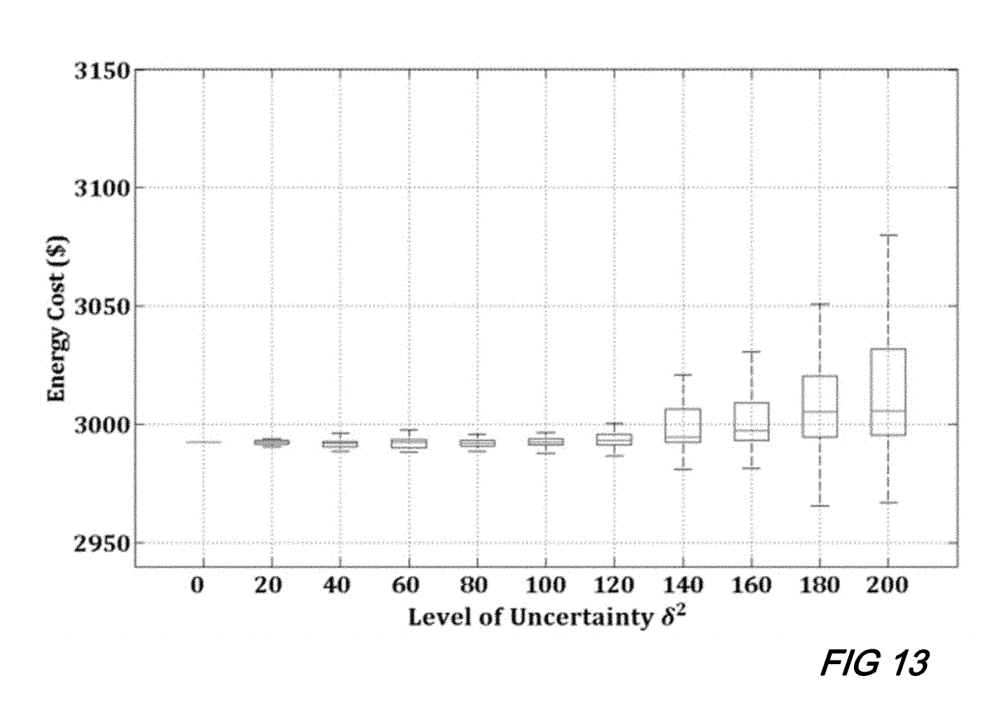

The daily energy cost from chiller operation is plotted in FIG. 13 under different forecasting uncertainty level. Monte-Carlo simulation was used to simulate the uncertainty. For each forecasting uncertainty level, 100 simulation runs are performed. The average energy cost for each variance σ² is indicated in FIG. 13. Compared to the baseline energy cost calculated from actual campus chiller operation of that specific day $3350, up to 12% cost saving can be achieved. As shown in FIG. 13, the proposed chiller operation management framework effectively addresses the different level of load forecasting uncertainty and achieves optimal chiller operation.

We have presented a multi-layer optimal chiller operation management framework. The first layer is the day-ahead 24-hour chiller operation planning layer which optimizes the chiller operation sequencing and load sharing based on predicted load profiles. A flexible and accurate modeling framework is constructed using piecewise linear programming. The MILP-based optimization is applied. In the second layer, a novel real-time dispatching layer deals with the load forecasting uncertainty in real-time, and maintains optimal chiller operation. Advantageously, our method solves forecasting uncertainty hierarchically based on the load uncertainty level. There are two steps of approaches being designed: rule-based chiller load sharing adjustment and MILP-based rolling optimization.

The management framework and methods according to the present disclosure is expermentally tested for a university campus chiller plant. With different forecasting uncertainty level being tested, the optimal operation results can reach up to 12% energy cost saving compared with the original campus chiller operation results. Further optimization can be achieved by extending this approach to chilled water flow and cooling tower management.

At this point, while we have presented this disclosure using some specific examples, those skilled in the art will recognize that our teachings are not so limited. Accordingly, this disclosure should be only limited by the scope of the claims attached hereto.

1. A computer implemented method of controlling and operating a multi-unit chiller system as part of a larger heating, ventilation and air conditioning (HVAC) system comprising:
receiving at a day-ahead, mixed-integer linear programming (MILP) based optimizer as input, a forecasted system load profile for the HVAC system;
generating a 24-hour operation schedule for the multiple chiller units including unit on/off sequences through the effect of a MILP optimization;
receiving at a real-time dispatcher real-time system load measurements and the 24-hour operation schedule;
generating in response to receiving the real-time system load measurements and the 24-hour operation schedule, real-time chiller operation commands; and
outputting the commands to individual chillers to effect their operation;
wherein said real-time chiller operation commands are generated by a method selected from the group consisting of: rule-based chiller load sharing and MILP based rolling optimization depending upon a determined discrepancy between the 24-hour schedule and the real-time measurements.

2. The computer implemented method of claim 1 further comprising:
generating a piecewise linearization to a chiller efficiency curve (P-Q curve) to generate an optimization with mixed-integer expressions, said optimization formulated as:
$${\sum }_{t = 1}^{T} {\sum }_{j = 1}^{N} {C}_{j}^{e} ( t ) + {C}_{j}^{s} ( t )$$
subject to a demand and load balance at time t represented by:
$${\sum }_{j = 1}^{N} {Q}_{j} ( t ) = D ( t ) ; t = 1 , 2 , … T$$
and a generation constraint for each chiller unit specified by:
Q_{min,j}≦Qⱼ(t)<Q_{max,j};t−1,2, . . . T;j=1,2, . . . N
wherein Cⱼ^{e}(t) is the energy cost at time period t of chiller unit j; Cⱼ^{s}(t) is the unit starting cost at time period t of chiller unit j; N is the number of chiller units; T is the number of periods in a time span; Qⱼ(t) is a load of chiller unit j at time t; D (t) is the system load demand at time period t; Q_{min,j} is the minimum operation load of chiller unit j; and Q_{max,j} is the maximum operation load of chiller unit j.

3. The computer implemented method of claim 2 further comprising:
determining, by the real-time dispatcher, system discrepancies between actual system load and forecast load;
adjusting load sharing among operating chillers through the effect of a rule-based procedure; and
adjusting load sharing among the chillers through the effect of a rolling optimization only when chiller start-up or shut-down is required.

4. The computer implemented method of claim 3 wherein said rolling optimization further comprises:
updating load forecasting for any remaining portions of a current day;
generating a remaining schedule through the effect of a MILP optimization.

5. The method according to claim 4 wherein said rolling optimization further comprises dynamically generating a set of minimum uptime constraints which define a minimum subsequent time period that a chiller should operate after being started.

6. The method according to claim 5 wherein said rolling optimization further comprises dynamically generating a set of minimum downtime constraints which define a minimum subsequent time period that a chiller should remain non-operational after being stopped.
